(19) United States
(12) Patent Application Publication
(10) Pub. No.: US 2008/0190305 A1
(43) Pub. Date: Aug. 14, 2008

(54) Food Product Slicer Wtih Carriage Drive

(75) Inventors: Guangshan Zhu, Richmond Hill, GA (US); Samuel A. Rummel, Pooler, GA (US); Shahram Shariff, Savannah, GA (US)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 12/063,283

(22) PCT Filed: Aug. 2, 2006
(86) PCT No.: PCT/US06/30066

§ 371 Date: Feb. 8, 2008

Related U.S. Application Data
(60) Provisional application No. 60/707,747, filed on Aug. 12, 2005.

(51) Int. Cl. A47J 43/04; B26D 5/00; B26D 1/143; G05B 19/00

(52) U.S. Cl. 99/537; 83/73; 83/474; 700/275

(57) ABSTRACT

A food product slicer with a food carriage drive is provided. The drive includes a manual assist mode that is responsive to operator applied force.

### TECHNICAL FIELD

The present invention relates generally to slicers used for cutting slices of a food product and more particularly to a food product slicer that includes a carriage drive.

### BACKGROUND

Typical food slicers have a base, a slicing knife for use in cutting a food product, a gauge plate for positioning the food product relative to the slicing knife and a carriage for supporting the food product as it is cut by the slicing knife. The carriage carries the food product by the cutting edge of the slicing knife, which slices a piece of food from the food product.

Typically, food carriages are driven manually or automatically past the cutting edge of the slicing knife. In slicers with an automatic carriage drive, the carriage is typically driven using a rotary motor and a mechanical linkage or other transmission arrangement that converts rotational output of the rotary motor into linear motion that drives the carriage a fixed travel distance between a start position and a fixed stop position. In some instances, an engage/disengage mechanism between the carriage and the transmission is provided for switching between automatic and manual slicing operations.

### SUMMARY

In one aspect, a food product slicer includes a slicer body and a slicer knife mounted for rotation relative to the slicer body, the knife having a peripheral cutting edge. An adjustable gauge plate enables varying of slice thickness. A food product support carriage is mounted for movement back and forth past the slicer knife and relative to the slicer body. A handle is connected with the carriage for operator application of force to move the carriage. A sensor is associated with the handle to produce an output indicative of operator movement force applied. A prime mover includes a moving portion connected for back and forth movement with the carriage. A controller is operatively connected with the prime mover for effecting movement of the moving portion to drive the carriage. The control is also operatively connected with the sensor, the controller operable in a manual assist mode in which the controller operates the prime mover at least in part in response to the output of the sensor for reducing required operator work input, the controller operable in a fully automated mode in which the controller operates the prime mover to automatically move the carriage without repeated reference to output of the sensor.

### BRIEF DESCRIPTION OF DRAWINGS

FIG. 1 is a side view of an embodiment of a slicer including power assisted food carriage;

FIG. 2 diagrammatically illustrates an embodiment of a feedback motor control loop;

FIG. 3 is a schematic front view of an embodiment of a user input device for use with the slicer of FIG. 1;

FIG. 4 is a schematic front view of another embodiment of a user input device for use with the slicer of FIG. 1;

FIG. 5 is a schematic front view of another embodiment of a user input device for use with the slicer of FIG. 1;

FIG. 6 is a schematic front view of another embodiment of a user input device for use with the slicer of FIG. 1;

FIG. 7 is a schematic front view of another embodiment of a user input device for use with the slicer of FIG. 1;

FIG. 8 is a schematic front view of another embodiment of a user input device for use with the slicer of FIG. 1;

FIG. 9 is a schematic front view of another embodiment of a user input device for use with the slicer of FIG. 1;

FIG. 10 is a schematic front view of another embodiment of a user input device for use with the slicer of FIG. 1;

FIG. 11 is a schematic front view of another embodiment of a user input device for use with the slicer of FIG. 1;

FIG. 12 is a schematic front view of another embodiment of a user input device for use with the slicer of FIG. 1;

FIG. 13 is a schematic front view of another embodiment of a user input device for use with the slicer of FIG. 1;

FIG. 13A is a detail view of the user input device of FIG. 13;

FIG. 14 is a chart of motor output versus signal for an embodiment of a user input device; and

FIG. 15 is a side view of another embodiment of a slicer including a linear motor for use in providing power assistance.

### DESCRIPTION

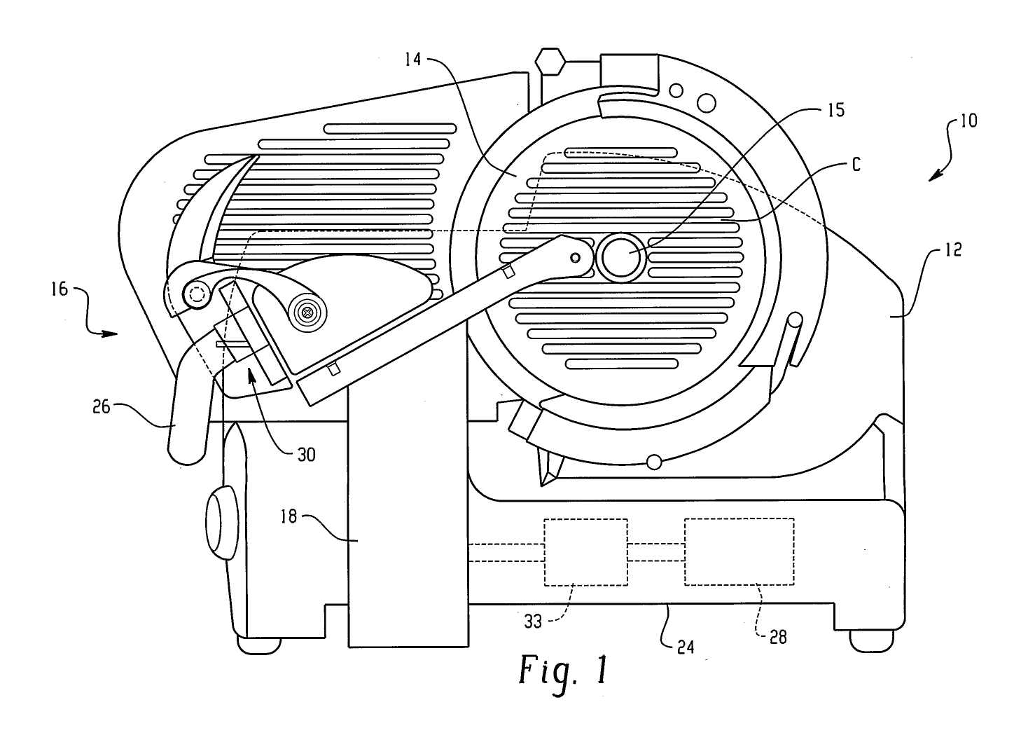

Referring to FIG. 1, a food product slicer 10 includes a housing 12 and a circular, motor-driven slicing knife 14 that is rotatably mounted to the housing on a fixed axis shaft 15. A food product can be supported on a manually operable food carriage 16 which moves the food product to be sliced through a cutting plane C and past the rotating slicing knife 14. The food carriage 16 reciprocates in a linear path in a direction generally parallel to the cutting plane C. Food carriage 16 is mounted on a carriage arm 18 that orients the food carriage at the appropriate angle (typically perpendicular) to the slicing knife 14 and reciprocates in a slot 24 within the housing 12. A handle 26 is mounted to the food carriage 16. The handle 26 is graspable by a user and can be used to manually operate the food carriage by directing the food carriage past a cutting edge of the slicing knife 14 and through the cutting plane C.

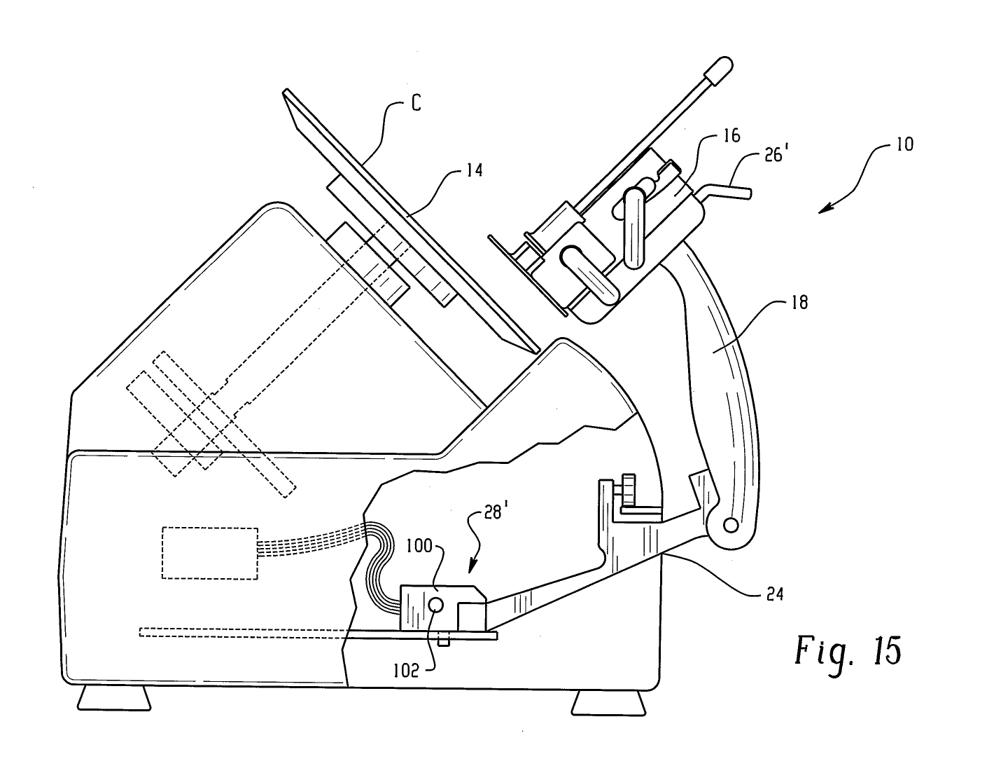

A motor 28 is connected to the food carriage 16 by a transmission 33 to drive or aid in driving the food carriage. Motor 28 can be of any suitable type such as a rotary or a linear motor. In some embodiments, such as in certain embodiments employing a linear motor 28′ as shown by FIG. 15, the food carriage 16 may be directly mounted to (or even form a part of) the linear motor (for example, such as a forcer 100 or stator 102 of the linear motor 28′). In other cases, as in certain embodiments employing a rotary motor such as the one depicted in FIG. 1, the transmission 33 may be used to transmit a rotational output of the rotary motor to drive the food carriage 16 linearly back and forth in slot 24 in a reciprocating fashion.

Slicer 10 includes a user input system 30 that is used by the slicer 10 in providing controlled power assistance during manual operation of the food carriage 16. The amount of work necessary to complete a desired slicing operation may vary, and each operator's ability to manually move a slicer carriage is unique. Some operators may have no problem, while for other operators manually moving the product carriage may be difficult. Providing power assistance to the operator will reduce the operator work required.

Motor 28, in some embodiments, provides only enough power for power assistance during a cutting operation. Typically, such a lower power motor 28 may provide slicer 10 incapable of slicing without manual input. This can allow for use of a relatively low power motor 28 that is relatively inexpensive. In these embodiments, slicer 10 may have only a manual only mode and/or a manual assist mode (i.e., manual plus power assistance). Alternatively, motor 28 be capable of higher power output, which can provide a slicer 10 having an automatic slicing mode where a slicing operation can be completed automatically without user input in addition to, for example, a manual only mode and a manual assist mode. As another alternative, a slicer may have just two modes when powered, namely a manual assist mode and an automatic slicing mode.

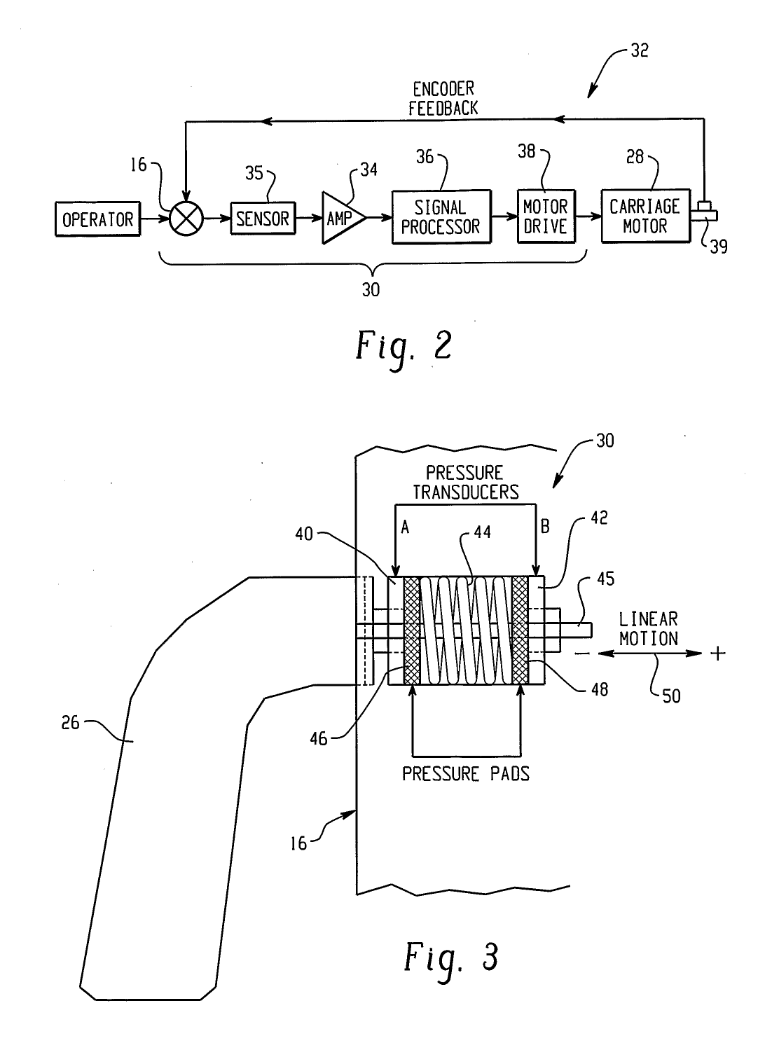

FIG. 2 shows an example of a control loop 32 for a power assisted slicing operation. User input system 30 includes a sensor 35 responsive to user applied force (direction, magnitude, or both) to food carriage 16, an amplifier 34 for amplifying a signal generated by the sensor, a signal processor or micro-controller 36 for processing the amplified signal information and a motor drive 38 that receives information from the signal processor or microcontroller for controlling motor 28 output. Motor 28 output, selected based on the information from the signal processor or micro-controller 36, is used to aid in driving the food carriage 16. Feedback for assistance for detecting the direction, magnitude or both of the manual force applied to the food carriage 16 can be achieved through use of numerous user input system embodiments, some of which are described below. In addition, an encoder arrangement 39 for producing an output indicative of carriage movement may also provide a feedback to be taken into account in the manual assist mode. Specifically, the controller may utilize the feedback to track carriage position along the carriage path and adjust its power assist operation accordingly (e.g., to avoid trying to drive the carriage beyond the end of its stroke even if an operator is pushing on the carriage handle or to reduce energization of the motor as the carriage approaches the end of its stroke).

The embodiments described below with reference to FIGS. 3-8 contemplate a carriage handle that is mounted on the carriage on the front or forward end of the carriage, such as the handle position shown in FIG. 1.

Referring to FIG. 3, user input system 30 includes carriage handle 26 that is moveably connected to food carriage 16. Handle 26 is connected to pressure transducers 40 and 42 such that linear movement of the handle translates into a corresponding pressure applied output signal from the pressure transducers. A spring 44 is located between pads 46 and 48. Each pad 46 and 48 is disposed at an opposing side of a respective pressure transducer 40 and 42. A handle carriage pin 45 extends through the spring assembly and is used to maintain handle alignment as the handle 26 is moved linearly. When the food carriage 16 is pushed in the positive direction (as denoted by the right side of arrow 50) using handle 26, spring 44 compresses in the positive direction resulting in increased pressure applied at pad 48, resulting in an increased signal level output by pressure transducer 42. Similarly, pulling the food carriage 16 in the negative direction (as denoted by the left side of arrow 50) using handle 26 causes the spring 44 to compress in the negative direction resulting in increased pressure applied at pad 46, resulting in an increased signal level output by pressure transducer 40. With the food carriage 16 at rest, the signal output by transducer 40 is substantially equivalent to the signal output by transducer 42. The signals are communicated to amplifier 34 for amplifying the signals and/or the signal processor or micro-controller 36 for processing the amplified signal information and for controlling motor 28 output, as described with reference to FIG. 2.

In an alternative embodiment, a single pressure transducer, for example pressure transducer 42, may be used. In this embodiment, the spring compression can be mechanically adjusted to achieve a mid-range signal (or datum signal) output by the pressure transducer 42 with the food carriage 16 at rest. When the food carriage 16 is pushed in the positive direction using handle 26, an analog pressure signal will increase above the mid-range setting due to increased pressure at pressure pad 42. Pulling the food carriage 16 in the negative direction using handle 26 will decrease pressure at the pressure pad 42 resulting in an analog pressure signal below the mid-range setting.

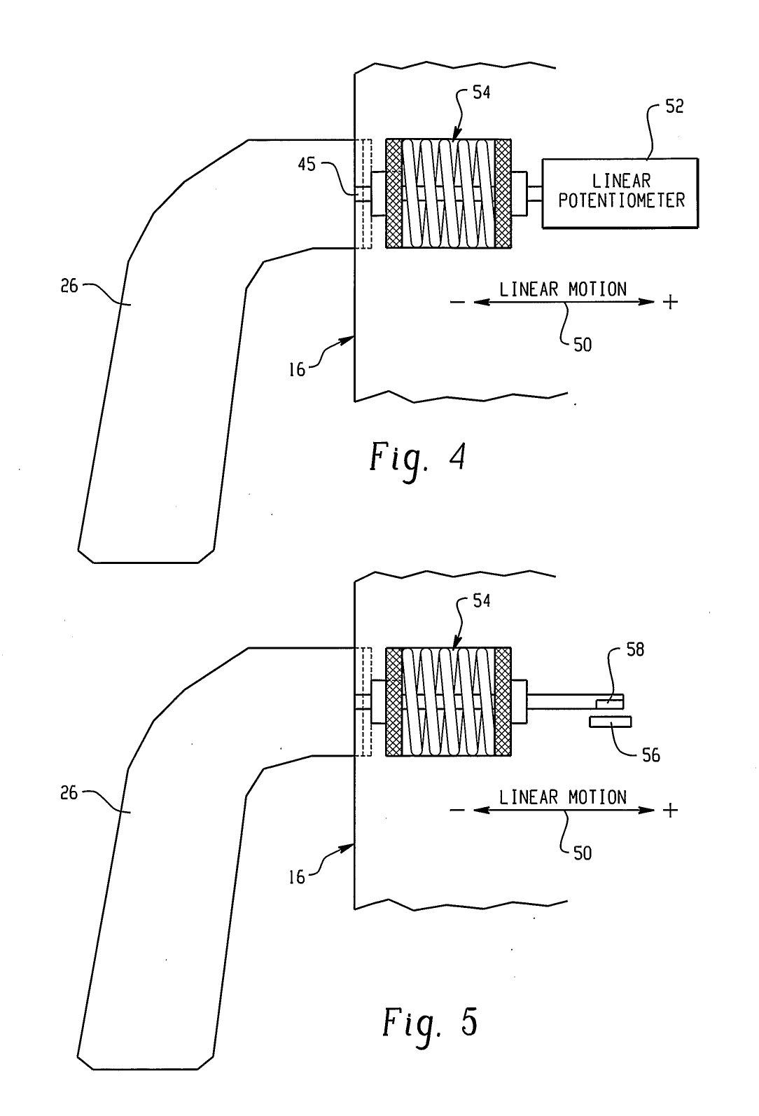

Referring to FIG. 4, a potentiometer 52 (e.g., a variable linear potentiometer) produces a signal change in response to linear movement of the handle 26 (as indicated by arrow 50). A spring assembly 54 is used to set a datum signal (e.g., that the food carriage 16 is not accelerating or that no manual force is being applied to the food carriage, for example, that the food carriage is at rest) by biasing the handle 26 and pin 45 toward an unloaded position. The potentiometer 52 is connected to the carriage handle pin 45 so that the resistance of the potentiometer can be directly proportional to the force applied to the handle 26. With the food carriage 16 at rest, the potentiometer 52 generates the datum signal. When the food carriage 16 is pushed in the positive direction using handle 26, the resistance of the potentiometer 52 changes resulting in a change in output signal indicating that a pushing force is being applied to the food carriage. Pulling the food carriage 16 in the negative direction using the handle 26 changes the resistance resulting in a change in output signal indicating that a pulling force is being applied to the food carriage. The signals are communicated to amplifier 34 for amplifying the signals and/or the signal processor or micro-controller 36 for processing the amplified signal information for controlling motor 28 output, as described with reference to FIG. 2.

Referring now to FIG. 5, a Hall effect sensor 56 produces a signal change in response to linear movement of the handle 26 (as indicated by arrow 50). In the illustrated embodiment, a magnet 58 is attached to the carriage handle pin 45. The Hall effect sensor 56 is at a fixed location and generates a signal in response to the position of the magnet 58 relative to the sensor. A spring assembly 54 is used to set a datum signal (e.g., indicating that the food carriage 16 is not accelerating or that no manual force is being applied to the food carriage, for example, when the food carriage is at rest) by biasing the handle 26 (and magnet 58) toward an unloaded position. When a displacement of the handle 26 occurs, a change in analog amplitude of the signal generated by the Hall effect sensor 56 occurs. In some embodiments, movement of the magnet 58 in the positive direction results in an increase in the analog amplitude of the signal generated by the Hall effect sensor 56 and movement of the magnet 58 in the negative direction will result in decreased analog amplitude of the signal generated by the Hall effect sensor 56. The signals are communicated to amplifier 34 for amplifying the signals and/or the signal processor or micro-controller 36 for processing the amplified signal information for controlling motor 28 output, as described with reference to FIG. 2. In some embodiments, the Hall effect sensor 56 moves (e.g., is attached to pin 45) and the magnet 58 is at a fixed location.

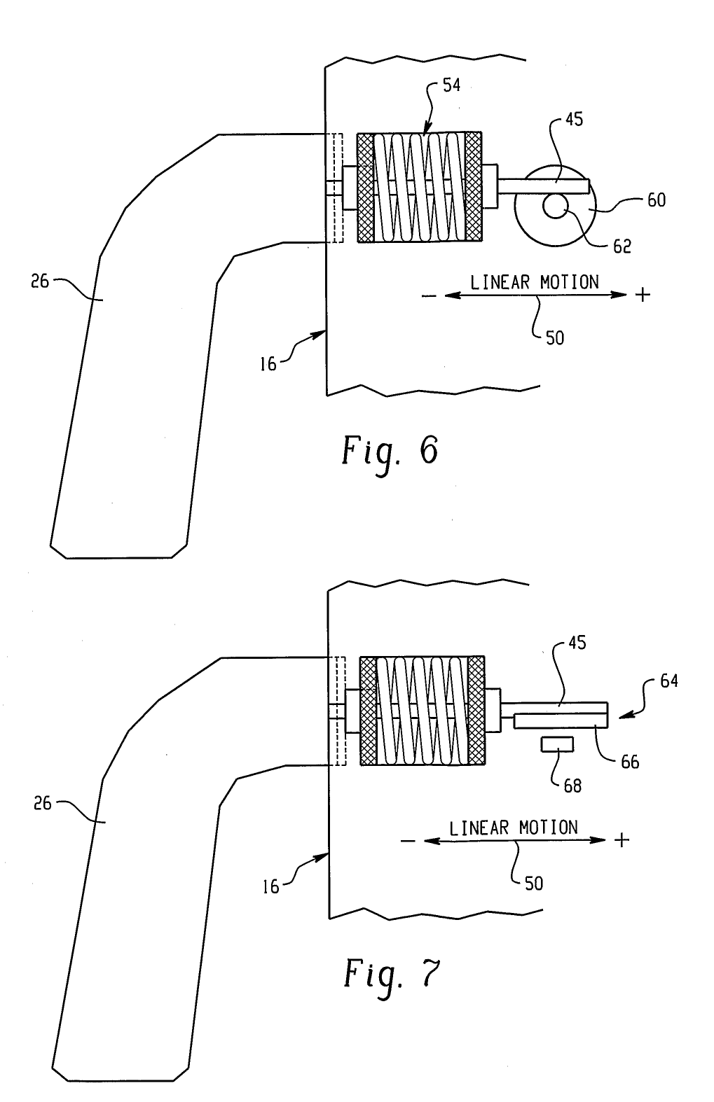

FIG. 6 shows another embodiment utilizing an absolute or incremental rotary encoder 60 to generate output signals (digital or analog) in response to linear movement of the handle 26. In this example, the carriage handle pin 45 contacts a rotary encoder shaft 62 of the rotary encoder 60. Spring assembly 54 is used to set a datum signal (e.g., indicating that the food carriage 16 is not accelerating or that no manual force is being applied to the food carriage, for example, when the food carriage is at rest) by biasing the handle 26 toward an unloaded position. Movement of the handle 26 in the positive direction (as indicated by arrow 50) causes the rotary encoder to rotate clockwise, while movement of the handle in the negative direction causes the handle to rotate counterclockwise. A signal is generated based on the angular position of the rotary encoder 60 where changes in the angular position of the rotary encoder result in changes in the signal that the rotary encoder generates. The signals are communicated to amplifier 34 for amplifying the signals and/or the signal processor or micro-controller 36 for processing the amplified signal information for use in controlling motor output, as described with reference to FIG. 2.

When using an incremental encoder, a reference mark signal from the rotary encoder 60 or external signal can be adjusted such that the signal is high to indicate that the food carriage 16 is at rest. An applied force in the positive direction results in rotation of the encoder shaft 62 in the clockwise direction with digital pulses occuring at outputs of channel A (not shown) and channel B (not shown) of the rotary encoder 60. The direction of the applied force is determined from a phase angle between channels A and B. The processor 36 monitors the incremental encoder pulse count from the reference mark to determine the force value.

When using an absolute encoder, in some embodiments, the encoder output signal is set at an absolute value of zero or 180 degrees when the food carriage 16 is at rest. The manually applied force can be directly related to the angular position of the rotary encoder 60 from the absolute value.

Referring to FIG. 7, an absolute or incremental linear encoder 64 provides power assist feedback. The linear encoder 64 is similar to the rotary encoder 60 described above except that the linear encoder readings are read directly over a linear distance. Linear encoder 64 includes a linear scale 66 attached to the pin 45 and a reader head 68 having a fixed location adjacent the linear scale. Alternatively, the reader head 68 can be attached to the pin 45 and the linear scale 66 can have a fixed location. Depending on the direction of the manually applied force to the handle 26, the encoder 64 output will change in a fashion similar to that described above with reference to FIG. 6.

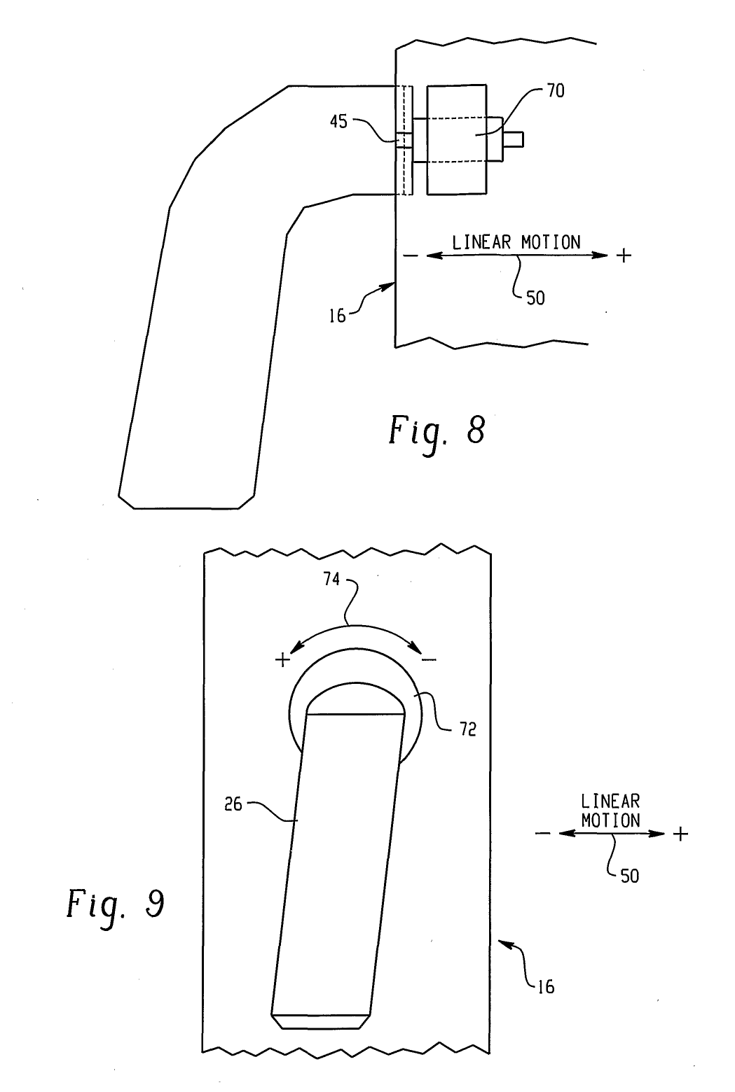

Some embodiments include a strain gauge to provide feedback. Referring to FIG. 8, strain gauge 70 is connected directly to the pin 45 and is capable of measuring tension and compression conditions in the pin 45 and generates signals corresponding to changes in the tension and compression conditions. The tension and compression conditions measured by the strain gauge 70 result from linear movement of the handle 26 in the direction of arrow 50.

Strain gauge 70 outputs a signal a reference signal (e.g., a signal level of zero) with the food carriage 16 at rest and no force applied to the handle. In some embodiments, when the food carriage 16 is pushed using the handle in the positive direction, the strain gauge 70 detects that the pin 45 is under a certain level of compression and outputs a certain signal corresponding to that level of detected compression. Pulling the food carriage 16 in the negative direction using handle 26 can cause the strain gauge 70 to detect that the pin 45 is under a certain level of tension and outputs a signal corresponding to that level of detected tension. The signals are communicated to amplifier 34 for amplifying the signals and/or the signal processor or micro-controller 36 for processing the amplified signal information for use in controlling motor output, as described with reference to FIG. 2.

The embodiments described below with reference to FIGS. 9-13 contemplate a carriage handle that is mounted on a side portion of the carriage, such as the handle position shown in FIG. 15 as handle 26′.

As an alternative to detecting (directly or indirectly) linear motion of the handle 26, rotary motion or handle torsion can be used. Referring to FIG. 9, feedback from an operator is provided using a torsion strain gauge sensor 72 connected to the handle 26. Torsion strain gauge sensor 72 is capable of measuring both tension and compression conditions resulting from manual application of force to the handle 26. When the food carriage 16 moves in the positive direction as shown by arrow 74 due to pushing force applied to the handle 26, the handle is under a counter-clockwise torsion compression. This counter-clockwise torsion compression is detected by the torsion strain gauge sensor 72 and a corresponding signal is output by the sensor. When the food carriage is moved in the negative direction due to a pulling force applied to the handle 26, the handle is under a clockwise torsion compression. This clockwise torsion compression is detected by the torsion strain gauge sensor 72 and a corresponding signal is output by the sensor. The signals are communicated to amplifier 34 for amplifying the signals and/or the signal processor or micro-controller 36 for processing the amplified signal information for use in controlling motor output, as described with reference to FIG. 2.

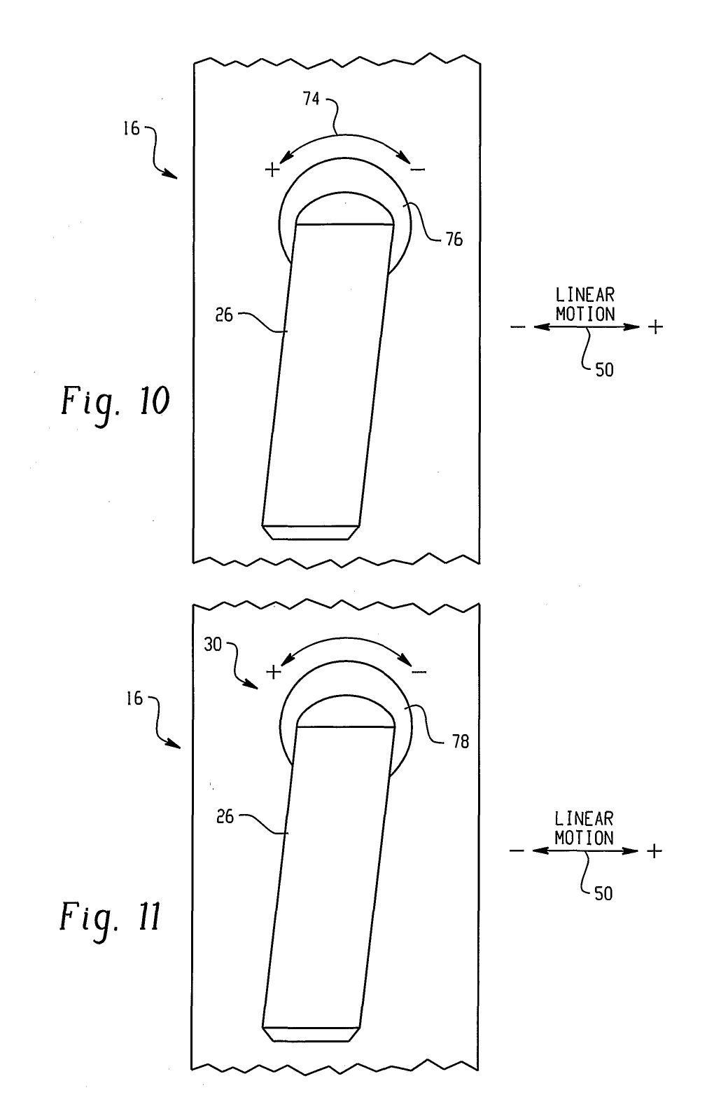

Referring now to FIG. 10, a rotary encoder 76 (e.g., absolute, incremental, or distance coded) is directly mounted to the handle 26 to measure the amount of force applied to the handle by the operator. The handle 26 is connected to the food carriage 16 in a manner that allows the handle to rotate in a controlled manner relative to the carriage. Direction of handle rotation is detected by the count up/count down value for embodiment utilizing an absolute rotary encoder and by phase angle between A and B signal channels for an incremental rotary encoder. The encoder count value will determine the direction of the power assist and amplitude determines the amount of motor output. A torsion spring (not shown) is mounted to the handle 26 to provide resistance to the rotational moment of the handle and return the handle to the idle position in the absence of operator applied force.

Referring to FIG. 11, user input system 30 includes a resistive potentiometer 78 that produces an output signal corresponding to an angular position of the handle 26 in a fashion similar to the embodiment of FIG. 4. A torsion spring (not shown) biases the handle 26 to a neutral or center position is the absence of any manually applied force. The signals generated by the potentiometer 78 are communicated to amplifier 34 for amplifying the signals and/or the signal processor or micro-controller 36 for processing the amplified signal information for use in controlling motor output, as described with reference to FIG. 2.

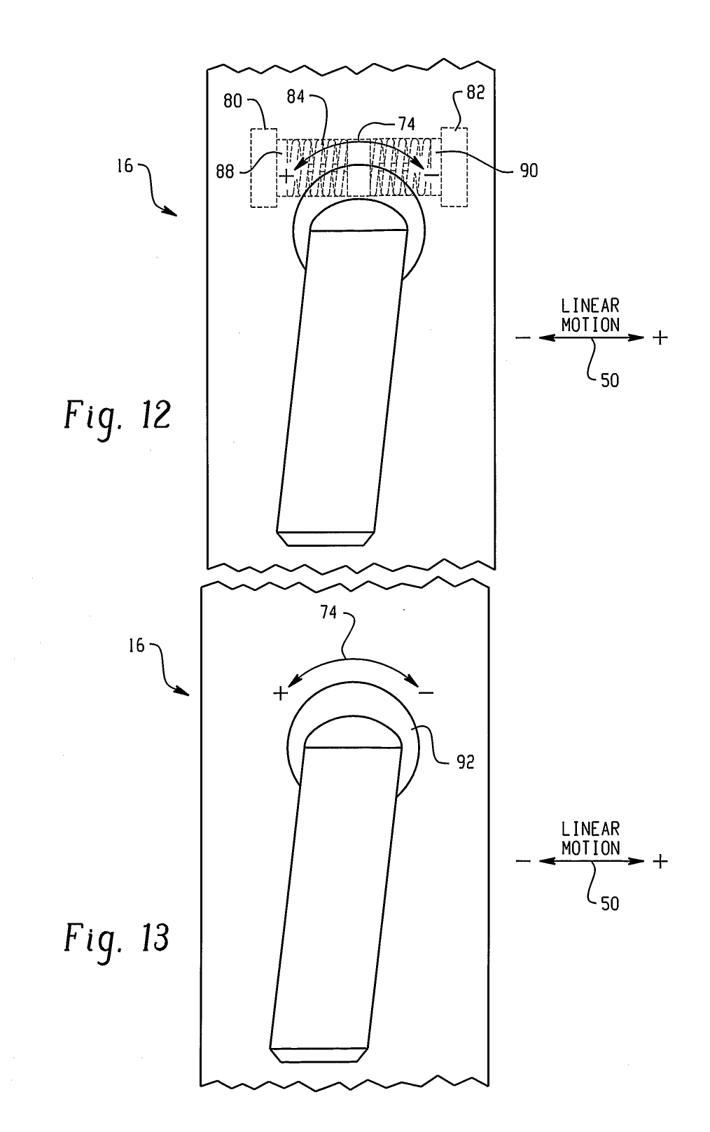

Referring to FIG. 12, pressure transducers 80 and 82 are used to provide feedback in response to rotation of the handle 26. Rotation of handle 26 in the direction of arrow 74 applies a force to spring 84 that increases (and/or decreases) pressure on at least one of pressure pads 88, 90. This increase (and/or decrease) in pressure is detected by one or both of transducers 80 and 82 and associated signals are produced. The signals are communicated to amplifier 34 for amplifying the signals and/or the signal processor or micro-controller 36 for processing the amplified signal information for use in controlling motor output, as described with reference to FIG. 2.

In the illustrated embodiment, when food carriage 16 is pushed in the positive direction using handle 26, an increase in pressure is applied through the spring 84 and detected at transducer 80 due to rotation of the handle. An increased signal level generated by the transducer 80 is the resultant of this increased pressure. Pulling the food carriage 16 in the opposite direction using handle 26 causes an increase in pressure applied through spring 84 at transducer 82 due to rotation of the handle 26 in an opposite direction. An increased signal level generated by the transducer 82 is the resultant of this increased pressure. Without any manual force applied to the handle 26, signals generated from both transducers 80 and 82 can be substantially equivalent, indicating that no power assistance should be applied.

In an alternative embodiment, only one pressure transducer, such as either one of pressure transducer 80 or 82, is used. Spring 84 is mechanically adjusted for a mid-range or datum signal with no manual force applied to the handle 26. When the food carriage 16 is pushed in the positive direction using handle, the analog pressure signal will increase above the mid-range setting. Pulling the food carriage 16 in the opposite direction using the handle will result in decreasing the analog pressure signal below the mid-range setting.

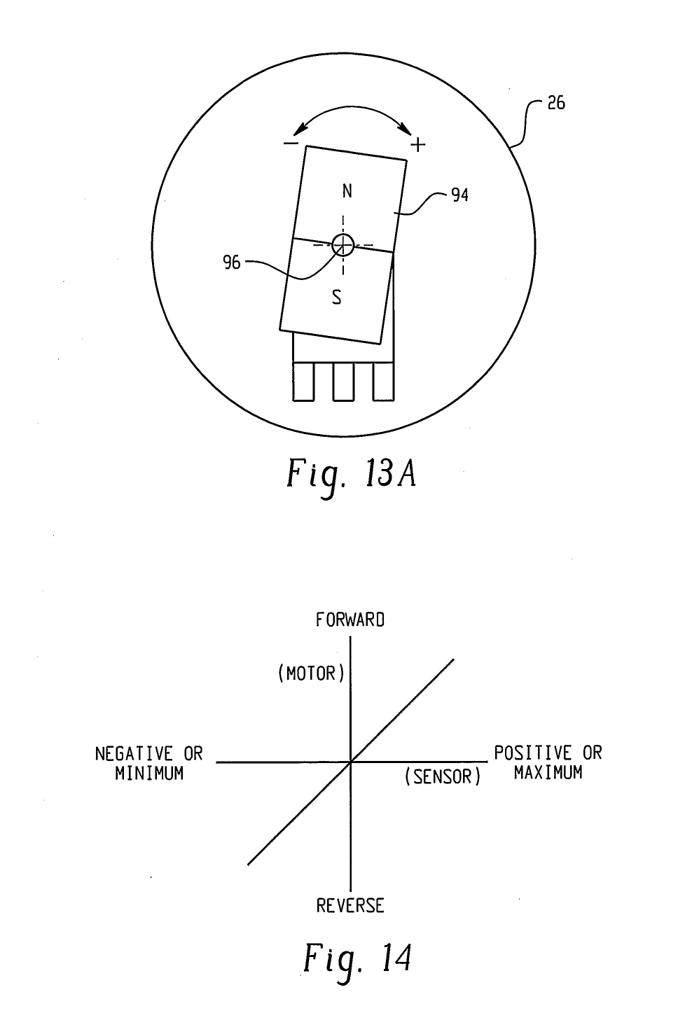

Referring to FIG. 13, an alternative embodiment employing a rotary Hall effect sensor 92 is shown. Handle 26 is connected to the rotary Hall effect sensor 92 such that rotation of the handle in the direction of arrow 74 is detected. A torsion spring (not shown) biases the handle to a neutral or central position indicating no manual force is being applied to the handle. Referring to FIG. 13A, the handle 26 is connected to a magnet 94 capable of rotating with the handle 26 about axis 96. As the handle 26 is rotated, corresponding rotation of the magnet 94 is sensed by Hall effect sensor 92, which generates an associated signal. The signals (analog or digital) are communicated to amplifier 34 for amplifying the signals and/or the signal processor or micro-controller 36 for processing the amplified signal information for use in controlling motor output, as described with reference to FIG. 2.

In connection with any of the embodiments of FIGS. 9-13, the rotary motion of the handle could also be converted to linear motion vi a gear or other mechanism, with a linear action sensor then being employed.

As noted above, it should be appreciated that the user input system 30 can be responsive to not only the direction of the applied force (e.g., through use of a positive or negative feedback signal generated by the sensor 35), but also to the magnitude of the changes in the manual force applied to the handle 26. The signal generated by the sensor 35 may provide an indication of a change in the magnitude of a manual force applied to the food carriage 16.

Referring to FIG. 14, an illustrative chart example indicating motor output (i.e., the level at which a motor is energized and therefore the level of power assistance) versus sensor output is shown for a slicer 10 embodiment with a power assist food carriage drive including a user input system. In embodiments where a motor is driven in opposite directions according to the desired direction of the carriage, signal amplitude can be used to determine motor output level and signal polarity can be used by the motor controller to determine motor output direction. Providing a slicer with such a power assist feature reduces that amount of operator work required, while at the same time provides an arrangement in which removal of an operator's hand from the carriage handle will cause the carriage to come to a stop.

Referring again to FIG. 15 in connection with a linear motor embodiment, the linear motor includes a stator 102 in the form of an elongated thrust rod or tube and a forcer 100 (sometimes referred to as an armature) in the form of a box-like housing that moves relative to the stator. Stator 100 is fixedly mounted within the slicer housing and is received by the forcer 102, which can move along the length of the stator. As used herein, “stator” refers generally to the stationary component of the linear motor and “forcer” refers generally to the moveable component of the linear motor. As such, in some instances, the rod may be the moveable component, i.e., the forcer and the box-like housing may be the stationary component, i.e., the stator.

Although the invention has been described and illustrated in detail it is to be clearly understood that the same is intended by way of illustration and example only and is not intended to be taken by way of limitation. For example, slicer 10 may include a hydraulically driven food carriage 16 that is driven by a hydraulic motor and a hydraulic pump or a set of hydraulic motors and pumps capable of rotating the slicing knife 14 and providing power assistance to the food carriage in a fashion similar to that described above. In the case pf a hydraulically driven food carriage the handle could be connected to a spring-biased centering valve to control hydraulic power assist given during a manual assist mode. Other variations are also contemplated.

What is claimed is:

1. A food product slicer, comprising:
a slicer body;
a slicer knife mounted for rotation relative to the slicer body, the knife having a peripheral cutting edge;
an adjustable gauge plate for varying slice thickness;
a food product support carriage mounted for movement back and forth past the slicer knife and relative to the slicer body;
a handle connected with the carriage for operator application of force to move the carriage;
a sensor associated with the handle to produce an output indicative of operator movement force applied;
a prime mover including a moving portion connected for back and forth movement with the carriage;
a controller operatively connected with the prime mover for effecting movement of the moving portion to drive the carriage, the control operatively connected with the sensor, the controller operable in a manual assist mode in which the controller operates the prime mover at least in part in response to the output of the sensor for reducing required operator work input, the controller operable in a fully automated mode in which the controller operates the prime mover to automatically move the carriage without repeated reference to output of the sensor.

2. The food product slicer of claim 1 wherein the moving portion is fixedly connected with the carriage.

3. The food product slicer of claim 2 wherein the prime mover is a linear motor, the moving portion is a forcer that moves along an elongated stator.

4. The food product slicer of claim 1 wherein, when the slicer is powered, the control lacks any manual only mode.

5. The food product slicer of claim 1 wherein the sensor is oriented to detect linear action of at least a portion of the handle.

6. The food product slicer of claim 5 wherein the sensor includes at least one pressure responsive element.

7. The food product slicer of claim 5 wherein the sensor includes at least one element for detecting linear movement.

8. The food product slicer of claim 1 wherein the sensor is oriented to detect rotary action of at least a portion of the handle.

9. Thee food product slicer of claim 8 wherein the sensor includes at least one element for detecting torque.

10. The food product slicer of claim 1 wherein the sensor includes at least one of a potentiometer, a pressure transducer, a hall effect sensor, a linear encoder, a rotary encoder, and a strain gauge.

11. The food product slicer of claim 1 wherein a spring biases the handle into a neutral position relative to the sensor.

12. The food product slicer of claim 1 further comprising an encoder arrangement for providing an output indicative of carriage movement, wherein, in the manual assist mode the controller operates the prime mover at least in part in response to the output of the encoder arrangement.
